(19) United States
(12) Patent Application Publication
(10) Pub. No.: US 2005/0213044 A1
(43) Pub. Date: Sep. 29, 2005

(54) Projection device having a mode selection unit

(75) Inventor: Adrianus Johannes Stephanes Maria De Vaan, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/507,198

(22) PCT Filed: Feb. 5, 2003
(86) PCT No.: PCT/IB03/00383

§ 371 Date: Sep. 9, 2004

(30) Foreign Application Priority Data
Mar. 14, 2002 (EP) 02076034.4

(51) Int. Cl. G03B 21/26

(52) U.S. Cl. 353/30

(57) ABSTRACT

The invention relates to a projection device for projecting an image comprising a light source (1), electro-optical light modulation (22) and image projection means (12) for projecting the image. In order to provide a projection device that can be used and is optimized for different modes, such as for video applications and business applications, the projection device according to the present invention further comprises a switchable module (3) comprising at least a first submodule (31), and a mode selection unit (20) for controlling said module (3) such that said first submodule (31) is either active or not active in the light path from said light source (1) to said image projection means (12), said first submodule (31) being adapted to improve the center brightness and white point of the light.

The invention relates to a projection device for projecting an image comprising a light source, electro-optical light modulation means and image projection means for projecting the image. The invention also relates to a corresponding method of projecting an image.

Projection devices, in particular LCD projection devices, are becoming more and more popular for business presentations, particularly for presenting graphic and/or PC data. However, due to the high price, the market of these projection devices for home video applications is still moderate. JP 07 084 553 A therefore proposes a projection liquid crystal display device which is capable of obtaining excellent contrast or luminance in accordance with each picture display and of obtaining an excellent display picture quality, even in the case of displaying a video or a PC picture. In this device, the diameter of an aperture which is located in the imaging path in front of a projection lens is controlled by a mode selection circuit. When displaying video data, the diameter of the aperture is reduced, which improves the contrast, whereas the brightness is enhanced when displaying a PC picture in which the diameter of the aperture is enlarged.

It is an object of the present invention to provide an alternative solution for a projection device which can be used and is optimised for at least two different modes and which avoids the need of controlling an aperture in the imaging path.

According to the present invention, this object is achieved by a projection device as defined in claim 1 which, in addition to the light source, the electro-optical light modulation means and the image projection means, further comprises a switchable module comprising at least a first submodule, and a mode selection unit for controlling said module such that said first submodule is either active or not active in the light path from said light source to said image projection means, said first submodule being adapted to improve the centre brightness and white point of the light.

In contrast to the known solution, the switchable module is not located in the imaging path within the image projection means or between the image projection means and a screen, but is located in the light path so that the light will already be influenced and optimised before it reaches the image projection means. In this way, a much better optimisation depending on the type of data (Video, PC) to be converted into an image for projection can be achieved. The first submodule provided according to the present invention is optimised for video applications which require a proper white point to obtain true colours, e.g. correct skin tones. Furthermore, the perceived picture quality for video applications is improved when there is more light in the centre of the screen with respect to the corners. If, instead of video data, graphic or PC data must be projected, the first submodule can simply be made inactive by the mode selection unit, e.g. by moving the first submodule out of the light beam. The present invention thus provides an inexpensive, yet very effective solution of a projection device which is usable and optimised for different kinds of applications.

As for contrast, a light distribution across the image provided by the solution known from JP 07084553 A is not optimised for these two different applications. In the projection device known from this document, only the contrast of the projected image can be improved by preventing light rays, which traverse the LCD panels at angles where the contrast is weak, from hitting the screen. This is achieved by reducing the size of a diaphragm, but this causes a loss of light, leading to a lower brightness.

In contrast, the present solution does not focus on contrast optimisation, but on light distribution across the image. In the case of data projection, a very homogeneous light distribution is required, i.e. the corner brightness needs to be almost similar to the centre brightness. For these images, the white colour is of lesser importance. The best picture performance is thus provided with this kind of application, i.e. a homogeneous illumination with a good colour brightness and minimum loss of light for colour generation.

In the case of video projection, a different light distribution is preferred. For these applications, the human eye likes the pictures more when the centre brightness is peaked. According to the present invention, this is achieved by another integrator module that distributes the light across the image in another manner. Compared to the data mode, light is now taken away from the corner and brought to the centre. For video, the human eye is very sensitive to proper colours (especially skin colours). This is achieved in this mode with an extra filter element that balances the colour channels and thus the white point.

Compared to the solution known from JP 07084553 A, the present solution has the advantage that the best brightness is achieved in both cases. Colour balancing has a further advantage. If the colour balancing is achieved by modifying the voltages applied to the LCD panels, this balancing will influence the contrast in the image. LCD projection systems have a limited contrast due to light-leakage of the panels, and this light-leakage remains identical when the voltages applied to the panels are modified for proper colour balancing, e.g. if the green channel needs to be dimmed by 40%, this will also involve a 40% lower contrast in the projected image (maximum brightness becomes 40% less, and dark state remains identical). In the case of the colour filter, both the bright state and the dark state are dimmed and the contrast is not changed.

Preferred embodiments of the invention are defined in the dependent claims. According to a first embodiment, the module is located between the light source and the light modulation means.

According to another preferred embodiment, the first submodule comprises an integrator module or a lens unit, particularly comprising two lenses for improving centre brightness and providing a better video performance.

It is further preferred that the first submodule comprises colour balancing filter means for balancing the light spectrum towards the required colour coordinates, particularly for video applications for adjusting a proper white point.

Instead of simply making the first submodule inactive when no video application is required, the module further comprises a second submodule according to another preferred embodiment of the invention, which second submodule is adapted to improve corner brightness and intensity of the light output. The mode selection unit is then adapted to control the module in such a way that either the first or the second submodule is active in the light path. The second submodule is thus optimised for business applications, i.e. for projection of graphic or PC data. This application requires a very homogeneous brightness of the entire image (high corner brightness) and a maximum light output, while a proper colour balancing is not required.

It is advantageous that the mode selection unit is adapted to automatically control the module based on the type of data to be converted into an image for projection. In this way, the module switches automatically in the correct mode, depending on the type of input data. It is thus preferred that the first submodule is active for video data, whereas the second submodule is active for graphic and/or PC data because the submodules are optimised for the corresponding applications.

Alternatively or in addition, a user interface can be provided for controlling the mode selection unit by a user who will then be able to select the correct mode.

The invention can be generally applied in any kind of projection device. A preferred application is in LCD projection devices where the electro-optical light modulation means comprise a three-panel liquid crystal display as particularly described in WO 01/19092.

The invention will now be explained in more detail with reference to the drawings, in which

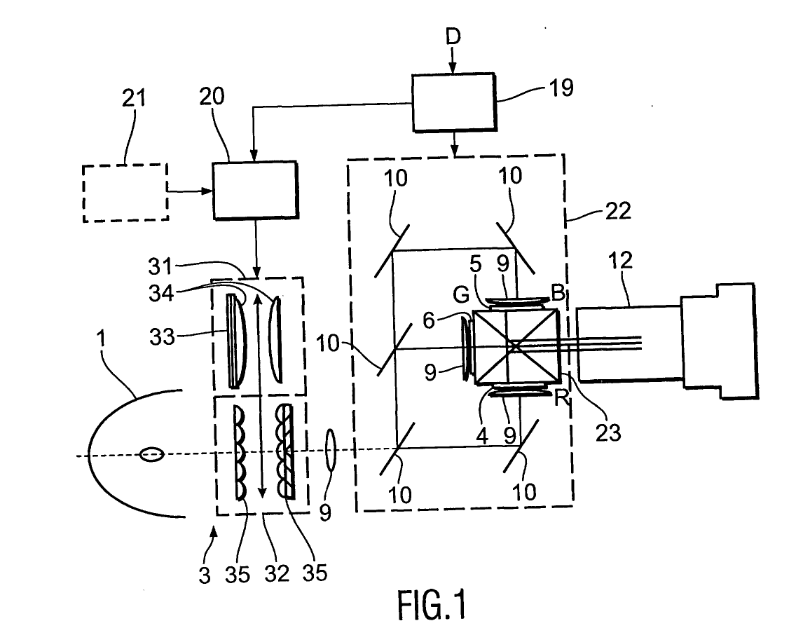

FIG. 1 shows a first embodiment of a projection device according to the invention, and

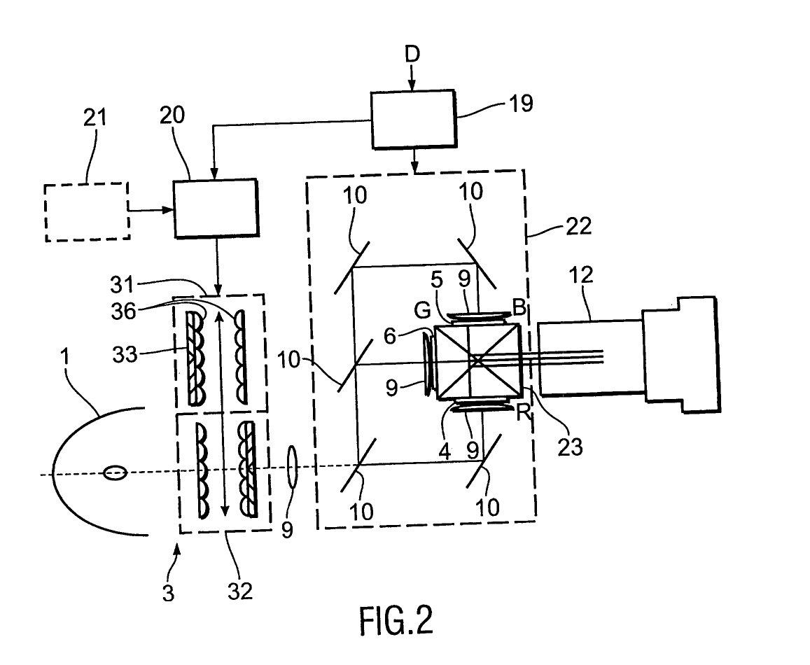

FIG. 2 shows a second embodiment of a projection device according to the present invention.

The projection device according to the invention shown in FIG. 1 comprises a light source 1, i.e. a projection lamp, such as an ultra-high pressure (UHP) lamp, having a curved reflector, electro-optical light modulation means 22 and a projection lens 12. The electro-optical light modulation means 22 comprise three electro-optical light modulation panels 4, 5, 6 with which a green (G), a red (R) and a blue (B) part, respectively, of an image to be projected are realized. Furthermore, lenses 9 and (dichroic) folding mirrors 10 are provided in said light modulation means 22 which are known per se and will therefore not be described in greater detail. Moreover, the light modulation means comprise a dichroic prism 23 arranged between the light modulation panels 4, 5, 6 and the projection lens 12. For more details of such a projection device, reference is made to WO 01/19092.

For driving the light modulation means 22, a projection drive unit 19 for supplying it with the information about the images to be projected is provided. The data D, such as video, graphic or PC data, are therefore applied to the projection drive unit 19.

According to the present invention, a switchable module 3 comprising a first submodule 31 and a second submodule 32 is provided in the light path between the light source 1 and the light modulation means M. Depending on the type of application, either one of said submodules 31, 32 is active in the light path while the other one is inactive. Said activity is controlled by a mode selection unit 20 which is connected to the projection drive unit 19 from which it receives information about the kind of data D and/or the kind of application so that the correct submodule 31 or 32 can be activated. In addition or alternatively, a user interface 21 can be provided to allow a user to switch between the first or the second submodule 31 or 32 via the mode selection unit 20.

The first submodule 31 comprises two (in general, one or more) lenses 34 and a spectral filter 33 for white balancing. It is optimised for video applications which generally require a proper white point to obtain true colours. Since the projection lamp 21 is usually deficient in blue and red light, the white point of the light emitted by the projection lamp is visibly shifted to green. To correct this in the case of video applications, the first submodule comprises the filter element 33 that balances the light spectrum towards the proper colour coordinates and adjusts the correct white point. Furthermore, it comprises the lenses 34 for improving the perceived picture quality by focussing more light on the centre of the display with respect to the corners, i.e. the corner brightness is reduced as compared with other applications.

The second submodule 32 comprises two lens plates 35 each carrying a number of lens elements. It is optimised for business applications, such as the projection of graphic or PC data. In such applications, a high corner brightness and a maximum light output are required. To maximize the brightness, no light is “wasted” for proper colour balancing.

Further elements like additional lenses, integrators and/or a polarizing beam splitter may also be provided but are not shown.

Either one of said submodules 31, 32 can be activated by the mode selection unit 20, e.g. by moving one of said submodules into the light path and moving the other submodule out of the light path.

In the embodiment shown in FIG. 2, the submodule 31 does not comprise the two lenses 34 but video integrator modules 36 comprising a lens plate carrying several lenses.

It should be noted that, according to alternative embodiments of the invention, the module 3 may only comprise the first submodule 31 which is activated for video applications, while for other applications the first submodule 31 is simply moved out of the light beam so that the light beam is not influenced at this point. According to still another embodiment, the module 3 may also be located at another position within the projection device. The invention may generally also be applied in other projection devices, particularly comprising different light modulation means.

1. A projection device for projecting an image, comprising:
a light source,
electro-optical light modulation means,
image projection means for projecting the image,
a switchable module comprising at least a first submodule, and
a mode selection unit for controlling said module such that said first submodule is either active or not active in the light path from said light source to said image projection means,
said first submodule being adapted to improve the centre brightness and white point of the light.

2. A projection device as claimed in claim 1, wherein said module is located between said light source and said light modulation means.

3. A projection device as claimed in claim 1, wherein said first submodule comprises an integrator module or a lens unit, particularly comprising two lenses.

4. A projection device as claimed in claim 1, wherein said first submodule comprises colour balancing filter means for balancing the light spectrum towards the required colour coordinates.

5. A projection device as claimed in claim 1,
wherein said module further comprises a second submodule adapted to improve corner brightness and intensity of the light output, and
wherein said mode selection unit is adapted to control said module in such a way that either said first or said second submodule is active in the light path.

6. A projection device as claimed in claim 1, wherein said mode selection unit is adapted to automatically control said module based on the type of data to be converted into an image for projection.

7. A projection device as claimed in claim 6, wherein said mode selection unit is adapted in such a way that said first submodule is active for video data and that said second submodule is active for graphic and/or PC data.

8. A projection device as claimed in claim 1, further comprising a user interface for controlling said mode selection unit by a user.

9. A projection device as claimed in claim 1, wherein said electro-optical light modulation means comprise a three-panel liquid crystal display.

10. A method of projecting an image, comprising the steps of:
generating light by means of a light source,
improving the centre brightness and white point of the light by means of a first submodule,
controlling the activity of said first submodule in the light path by means of a mode selection unit,
modulating the light by means of an electro-optical light modulation means,
projecting the image by means of an image projection means.
